(19) United States
(12) Patent Application Publication
(10) Pub. No.: US 2016/0006144 A1
(43) Pub. Date: Jan. 7, 2016

(54) PHONO CONNECTOR

(71) Applicant: NORDOST CORPORATION, Holliston, MA (US)

(72) Inventors: Joseph M. REYNOLDS, Framingham (US); William D. MITCHELL, Holliston, MA (US)

(73) Assignee: Nordost Corporation, Holliston, MA (US)

(21) Appl. No.: 14/391,757

(22) PCT Filed: May 7, 2014
(86) PCT No.: PCT/US14/37053

§ 371 Date: Oct. 10, 2014

Related U.S. Application Data
(60) Provisional application No. 61/821,025, filed on May 8, 2013.

(51) Int. Cl. H01R 9/05; H01R 13/625

(52) U.S. Cl. CPC H01R 9/0527; H01R 13/625

(57) ABSTRACT

A co-axial electrical connector having an outer shell and a co-axially positioned center signal pin with a resonator ground conductor.

### CROSS-REFERENCE TO RELATED APPLICATION

This application claims the benefit of U.S. Provisional Application No. 61/821,025, filed May 8, 2013.

### FIELD OF THE INVENTION

This invention relates to plug connectors, consisting of a center signal pin and an outer shell, which are widely used for electrical connections. These connectors commonly are referred to as “RCA Connectors.”

### BACKGROUND OF INVENTION

An RCA phono-type plug mates with an RCA phono-type socket. RCA plug designs have been criticized by electrical engineers in the audio and other electrical disciplines.

The typical RCA plug connector has no latching mechanism to secure the plug to its mating socket. Additionally, after many mating and un-mating cycles, the thin cylindrical slotted retaining ring of an original RCA plug and socket loses its spring temper, creating a poor electrical connection. This results in noise and high electrical resistance, due to the reduction of the mating forces. The original RCA socket design diameter center pin and an outer solid band of 0.333″ (8.46 mm) diameter. However many manufacturers of the RCA socket have not always precisely designed or manufactured to these dimensions. Many can vary as much as +−0.008″ (0.20 mm) on the outer band.

In the termination area on a typical RCA plug, there is the potential for electrical shorting of the center pin wire(s) to the outer ring wire(s) due to mutable wires, braid or large solder joints.

When using an RG coaxial cable type in the typical RCA plug, the braid is twisted into a single stranded conductor which is then soldered to the connector creating the potential for electrical shorting to the center pin that is exposed in the solder termination area.

In the typical RCA connector the signal and ground wires (braid) are cut to different lengths, sometimes as much as 0.375″ (9.52 mm) witch separate them from shorting in the solder area within. the connector.

### SUMMARY OF INVENTION

The connector of the invention allows for the termination of wire(s) to the center signal pin, which is removable from the connector insulating housing. The pin is a rear entry design to allow full insertion into the connector housing, preventing any possibility of shorting to the grounding termination ring. A resonator ground conductor is positioned between the housing and the insulating sleeve for grounding. The center signal in is retained in the connector housing by means of a circular spring retaining ring.

The rear termination area of the connector insulating housing designed with flutes to arrange the cable ground wires in an even 360° circular pattern around the center signal pin.

The front conductive ground mating ring is a 360° design to achieve maximum retention force with the mating connector. This design. gives multiple contact points for redundancy, to prevent fretting caused by micro vibrations reacting at the mating points.

The overall design maintains coaxial type grounding design around a central signal conductor pin, thus improving signal distortion, by maintaining dimensional concentricity of the ground to the signal conductor.

The plug design allows both the signal and ground wires (braid) to be cut to the same length. Therefore, the solder joint locations in the connector are at the same point, keeping equal lengths of all the conductors.

### BRIEF DESCRIPTION OF THE DRAWINGS

FIG. 1 is a perspective view of the phono connector of the invention.

FIG. 2 is an exploded view of the phono connector of FIG. 1.

FIG. 3 is a side elevational view of the phono connector of FIG. 1.

FIG. 4 is a cross-sectional view taken along the line AA in FIG. 3.

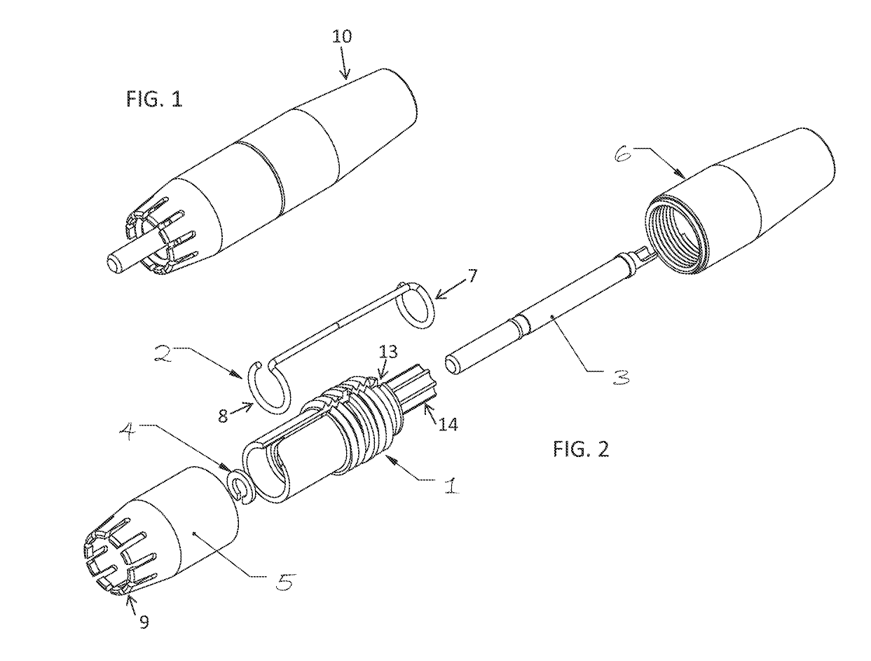

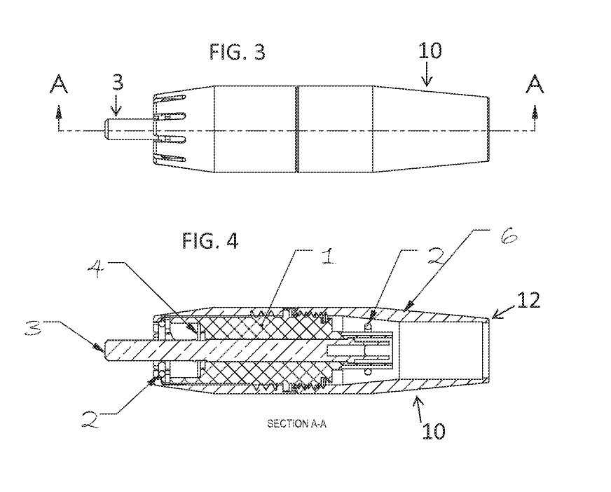

### DETAILED DESCRIPTION OF THE INVENTION

The phono connector (10) shown in FIGS. 1 through. 4 addresses the problems described above. The connector generally comprises a front cover or shell (5), a rear cover or housing (6) and a central signal pin (3).

The front connector shell or housing (5) is adopted to mate with an electrical phono-type socket (not shown) and is made from a bronze spring type material for a robust design.

The rear metallic cover or housing (6) is designed with a cable stop (12) that is used as a cable jacket strain relief when used in conjunction with a hog type crimp ring.

A center signal pin (3) carries signals from the conductor wires and is adopted to mate with an electrical phono-type socket (not shown). The center signal pin (3) is coaxial with the front and rear housings (5, 6).

A resonator ground conductor is made from a phosphorous bronze alloy. The resonator ground. conductor (2) has a ground 360° termination ring (7) on the same plane as the soldered connector wire (s) in the center signal pin (3) of the connector (10). For multiple wire grounds the rear of the connector insulator (1) has external flutes (14) in the insulator allowing up to 8 separate ground wires to be soldered in an evenly spaced circular pattern around the center pin. If using a RG coax cable, the braid is put over the outside of the termination ring (7), soldered 360°, and covered with a shrink tube. The conductor (2) fits within a groove in the insulation (13).

With a rear entry center signal pin (3) design, the soldering of the connector wires to the center in is performed outside the connector insulator (1). The solder joint area can be covered with a shrink tube for added protection. The plurality of flutes (14) of the insulator (1) is used to arrange the wires in a circular pattern. The center signal pin (3) is inserted into the connector insulator (1) (POM, PTFE, Ceramic, FR4) and retained by a copper alloy spring retaining ring (4). This allows the center pin (3) some float for alignment to the mating socket.

A mating ring (8) is on the resonator ground conductor (2) on the opposite end from the terminator ring (7).

Front supporting flutes (9) on the front shell (5) are designed to address the different diameters of a mating band on the mating socket. The copper spring alloy wire preferably is formed to tight tolerances. The spring pressure of the spring wire, with its 360° contact area creates a mechanical grip on the mating band. This also creates a maximum contact wiping area, on the mating band, which decreases the possibility of contact fretting caused by micro vibrations that occur in low current contact points long connection times. The 360° spring design has been mated and un-mated (1 cycle) in excess of 1000 cycles with minimal reduction in mating and un-mating forces.

Other embodiments of the present invention may be contemplated within the spirit and scope of the invention.

1. A co-axial connector, comprising
a. a shell adapted to mate with an electrical socket at one end;
b. a center conductive pin co-axially positioned within the shell so that the pin is able to mate with the electrical socket;
c. an insulating sleeve positioned between the conductive shell and the center conductive pin; and
d. a resonator ground conductor positioned between the shell and the insulating sleeve for grounding.

2. A co-axial connector as in claim 1, further comprising a retaining ring on the center conductive pin which allows for movement of the center conductive pin relative to the shell.

3. A co-axial connector as in claim 1, further comprising a plurality of flutes on the one end of the shell to allow the shell to mate tightly with the electrical socket.

4. A co-axial electrical connector as in claim 1, wherein the resonator ground conductor holds the center conductive pin coaxially positioned in the shell.

5. A. co-axial electrical connector as in claim 1, wherein the resonator ground conductor is positioned within a longitudinal groove in the insulating sleeve.

6. A co-axial electrical connector as in claim 1, wherein cable wires are attached to a second end of the center conductive pin so that the pin and the cable wires can be inserted into or removed from the shell at the rear end thereof.
